(19) United States
(12) Patent Application Publication
(10) Pub. No.: US 2022/0347498 A1
(43) Pub. Date: Nov. 3, 2022

(54) RESPIRATOR CARRIER

(71) Applicant: 3M INNOVATIVE PROPERTIES COMPANY, St. Paul, MN (US)

(72) Inventors: Sabeel Ullah, High Wycombe (GB); Christopher P. Henderson, High Shincliffe (GB)

(21) Appl. No.: 17/597,637

(22) PCT Filed: Jul. 14, 2020
(86) PCT No.: PCT/IB2020/056600

§ 371 Date: Jan. 14, 2022

(30) Foreign Application Priority Data
Jul. 17, 2019 (EP) 19186672.2

(51) Int. Cl. A62B 18/08; A62B 18/02; A62B 9/00

(52) U.S. Cl. CPC A62B 18/08; A62B 18/025; A62B 9/00

(57) ABSTRACT

The invention relates to a respirator carrier frame 1 comprising a central frame portion 2, two wing portions 3 extending on opposing sides from the central frame portion 2, as well as at least one hinge 4 between the central frame portion 2 and each of the two opposing wing portions 3.

The invention relates to a respirator carrier frame comprising a central frame portion as well as two wing portions extending on opposite sides from the central frame portion. The invention also relates to a set of parts for a respirator.

Respirators are commonly worn over the breathing passages of a person for at least one of two common purposes: (1) to prevent impurities or contaminants from entering the wearer's breathing track; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is a risk of contamination to other persons or things, for example in an operating room or clean room.

Some respirators are categorized as being “filtering face-pieces” because the mask body itself functions as the filtering mechanism. Unlike respirators that use rubber or elastomeric mask bodies in conjunction with attachable filter cartridges, filtering face-piece respirators have the filter media comprise much of the whole mask body so that there is no need for installing or replacing a filter cartridge. As such, filtering face-piece respirators are relatively light in weight and easy to use.

Filtering face-piece respirators generally fall into one of two categories, namely shaped respirators and fold-flat respirators. Shaped respirators are more-or-less permanently formed into a desired face-fitting configuration and generally retain that configuration during storage and use. Shaped filtering face-piece respirators regularly include a molded supporting shell structure, generally referred to as a “shaping layer”, which is commonly made from thermally bonding fibers or an open-work plastic mesh. The shaping layer is primarily designed to provide support for a filtration layer. Relative to the filtration layer, the shaping layer may reside on an inner portion of the mask (adjacent to the face of the wearer), or it may reside on an outer portion of the mask, or on both inner and outer portions.

Unlike shaped respirators, fold-flat respirators are stored flat but include seams, pleats, and/or folds that allow the mask body to be opened into for example a cup-shaped configuration for use. Some commercially available pleated respirators have been designed with pleated structures that unfold or expand when the respirator is being placed on the wearer's face, such as for example three-fold respirator masks. Some of these known products do use a support structure to define the shape of the respirator mask body, others do not use a support structure to define the shape of the mask body.

WO 2012/ 067791 A1 discloses a shaped respirator with a filtering face-piece that comprises a mask body and a harness. The mask body includes a supporting frame structure and a filtering structure. The frame structure is injection molded onto the filtering structure such that the frame structure becomes bonded to the filtering structure.

Another example of a filtering face-piece respirator that has a support structure and a filtering structure is disclosed in US 2009/0078265 A1. The known filtering face-piece respirator comprises a reusable support structure with transversely extending members that may be moved towards and away from each other over a living hinge. The filtering structure may be secured at the support through a temporary joining mechanism. The ability to move the transversely extending members relative to each other enables the mask body to better accommodate wearer jaw movements.

WO 2014/025776 A1 discloses a filtering face-piece respirator that includes a reusable harness, a reusable frame and a replaceable filtering structure. The reusable frame has the reusable harness secured to it and has first and second opposing panels that define a slot into which the replaceable filtering structure can be manually inserted to be joined to the reusable frame in a removeable fashion. The replaceable filtering structure is able to be separated from the reusable frame by being manually withdrawn from the slot.

In view of the above cited prior art there is still a need for a respirator system such as for example a filtering face-piece with a support structure and a filtering structure, wherein the support structure on the one side supports and stabilizes the filtering structure and on the other side is flexible enough that the respirator system may be folded into a space saving form, for example for storing purposes.

The present invention provides a respirator carrier frame or a respirator support structure comprising
a central frame portion;
two wing portions extending on opposing sides from the central frame portion, as well as
at least one hinge between the central frame portion and each of the two opposing wing portions.

The invention relates to a respirator carrier frame or a respirator support structure for a filtering structure. The carrier frame according to the invention supports and stabilizes a filtering structure during use. It may provide over additional functionalities. It also supports folding of the carrier frame with a filtering structure. The respirator carrier frame according to the invention provides a central frame portion as well as two wing portions extending from the central frame portion. The wing portions extend on opposite sides of the central frame portion. The central frame portion and the two wing portions are each connected with each other through at least one hinge, wherein the hinge allows relative movement of the two hinge portions towards the central frame portion.

The central frame portion may for example be connected to a central portion of a filtering structure and the two wing portions may for example be connected to two outer portions of the same filtering structure. The filtering structure may for example be a disposable filtering structure, that needs to be exchanged after a certain time of use. The respirator carrier frame may be used to provide stability to the disposable respirator or a disposable filtering face-piece. The respirator carrier frame may also be used to help shaping the disposable filtering structure. By providing a respirator carrier frame with integrated hinges towards the two wing portions, it is possible to fold the respirator carrier frame together with the thereto attached disposable filtering structure into for example a flat form or a smaller form, which allows storing the respirator carrier frame together with the filtering structure in a space saving manner, when it is not used. This might help to store the products when not used, for example in a pocket, and also to store the products for shipping purposes in a space saving manner in a box.

The respirator carrier frame may be made out of any material, that allows cost effective manufacturing and that provides enough stability to a filtering structure in a folded as well as in an unfolded state. The material may also be selected such as to provide a reasonable weight that does not influence a wearer's comfort while wearing a respirator system with a respirator carrier frame according to the invention. The materials for the frame may include metal, polymers such as polypropylene, polyethylene or PVC and a combination of the before mentioned materials.

The central frame portion may provide any shape that provides enough stability so that the two wing portions may be connected to the central frame portion and that the carrier may be folded and unfolded again. This folding and unfolding of the carrier also needs to be performed easily when a filter structure is attached to it. The central frame portion may provide any shape that is stable enough to help shaping the mask and to assist the carrier frame in all folding activities. The central frame portion may be flat, or it may be curved to provide a better support with bringing the filtering structure in the correct shape. It may for example comprise a rectangular shape. It may also comprise an essentially rectangular shape. Or it may comprise any other shape providing the above-mentioned characteristics; it may for example be of oval shape, square shape, circular shape or triangular shape.

The central frame portion may comprise an outer frame structure, for example an outer rectangular frame structure. It may also comprise an outer oval, square, circular or triangular frame structure. In addition, the central frame portion may comprise an inner stiffening structure. The inner stiffening structure may for example comprise stiffening struts extending inside of the outer frame structure, for example two parallel stiffening struts extending from one side of the outer frame structure to the other side, e.g. in a horizontal manner.

According to one embodiment each of the hinges between the central frame portion and the wing portion comprises at least one arm extending from the outer frame structure of the central frame portion. Each wing portion may comprise one arm or more than one arm, to build a hinge between the central frame portion and the wing portion.

It is possible that the central frame portion extends towards the side and thereby covers and stabilizes most of the respirator system. The extension towards the side may be realized through at least one arm, strut or bar extending from the central frame portion towards each side, where the wing portions are located. The opposing wing portions may for example be hinged to these extensions of the central frame portion.

Each of the hinges between the central frame portion and the opposing wing portions may comprise at least one arm extending from the outer frame structure of the central frame portion. As already pointed out, it may further comprise a corresponding arm extending from the wing portion. Both arms may comprise a through-hole for receiving a bolt, which allows a relative movement between the central frame portion and the opposing wing portions. In order to provide more stability to the hinge, one side, either the central frame portion or the wing portion, may provide two spaced apart, parallel arms for receiving the corresponding arm between them. Again, all arms may comprise through-holes for receiving a bolt, which allows a relative movement between the central frame portion and the opposing wing portions. According to one embodiment the hinge is designed such that when the hinge starts to articulate from a closed position there is full movement, but once the hinge has reached its open position the movement is restricted, for example to plus/minus 10 degrees either side of its open position. This might be helpful to prevent the mask from inadvertently being closed when moved. This may be achieved be designing the mechanical interface of the hinge elements in the open position such that friction is increased.

According to one embodiment of the invention, each of the hinges between the central frame portion and the wing portions allows a translational as well as a rotational movement of the wing portions relative to the central frame portion. Such an embodiment allows for more flexibility regarding the positions the wing portions can be put in, in relation to the central frame portion, since the range of possible positions for the wing portions relative to the central frame portion is expanded a lot. Such a configuration provides a lot of flexibility regarding the shapes of a filtering structure that the respirator carrier frame can support.

It is possible that either the arm or the arms of the hinge that extends from the central frame portion or the arm or the arms that extend from the wing portions comprise an elongated through hole as part of the hinge. Such a configuration provides one technical solution that allows a rotational and a translational movement of the wing portions relative to the central frame portion.

Each wing portion may comprise at least one crossbar extending from the central frame portion towards an outer bar. The outer bar may be used for attaching for example a headband system for the respirator. Each wing portion may for example comprise two crossbars, extending from the central frame portion towards an outer bar connecting the two arms. The two crossbars may for example extend essentially parallel to each other from the central frame portion. The two crossbars may also be arranged with an angle relative to each other. The wing portions may also comprise more than two arms. Each wing portion may comprise a different number of crossbars than the opposing wing portion. The crossbars may be straight, or they may be curved, or they may provide both forms.

The two crossbars of the wing portions may comprise a though-hole to establish the hinge connection at the end that faces the central frame portion facing end. The central frame portion may provide for each hinge two parallel spaced apart arms for receiving the end of the crossbars that provides the through-hole. The through-hole may be circular, or it may be elongated as described above.

According to another embodiment, each wing portion may provide an additional hinge for folding the wing portion in itself. The additional hinge may be designed as a hinge allowing a rotational movement only. It may also be designed allowing rotational and translational movement. One technical possibility for a hinge allowing rotational and translational movement is to provide one side of the two sides building the hinge with an elongated through-hole. For the respirator carrier frame at least one of the hinges — either between the central frame portion and the wing portion or between two parts of the wing portion — may provide a hinge that allows a rotational as well as a translational movement. It is also possible that both hinges allow both kind of movements.

The respirator carrier frame may comprise means for attaching a filtering structure. The means may be all kind of known means for attaching a filtering structure to a frame that can be used frequently. Examples of such attachment means may include mechanical attachment means, adhesive attachment means and physical attachment means, such as for example snap fit connections, hook and loop connections, reusable adhesive connections.

The respirator carrier frame may also comprise means for attaching additional components, such as for example an exhalation valve, headbands or electronic components. Examples for such attachment means may include mechanical attachment means, adhesive attachment means and physical attachment means, such as for example snap fit connections, hook and loop connections, reusable adhesive connections.

The size and the shape of the central frame portion may be adapted to receive an outer housing of an exhalation valve. The central frame portion may be designed such that it may receive the outer housing of the exhalation valve through a snap fit connection. It may also be designed such that it may receive the outer housing of the exhalation valve through any other reusable attachment means. It has become more and more popular to provide filtering face-pieces with exhalation valves. These exhalation valves serve as an additional connection between the space encircled by the filtering structure and a wearer's face and outside of the filtering structure to provide additional exchange of for example the humidity and temperature.

The invention also relates to a kit of parts for a respirator system comprising a respirator carrier frame as described above as well as at least one disposable filtering structure. The respirator carrier frame and the disposable filtering structure may be detachable connected to each other such that the carrier frame may be reused with a number of filtering structures and the filtering structure may be exchanged after being used. The kit of parts may also provide more than one disposable filtering structure, for example two, three, five or ten disposable filtering structures.

The respirator carrier frame may be designed such, that it may be used with a number of different filtering structures. It may also be designed such that it may only be used with one specific filtering structure.

The invention will now be described in more detail with reference to the following Figures exemplifying particular embodiments of the invention:

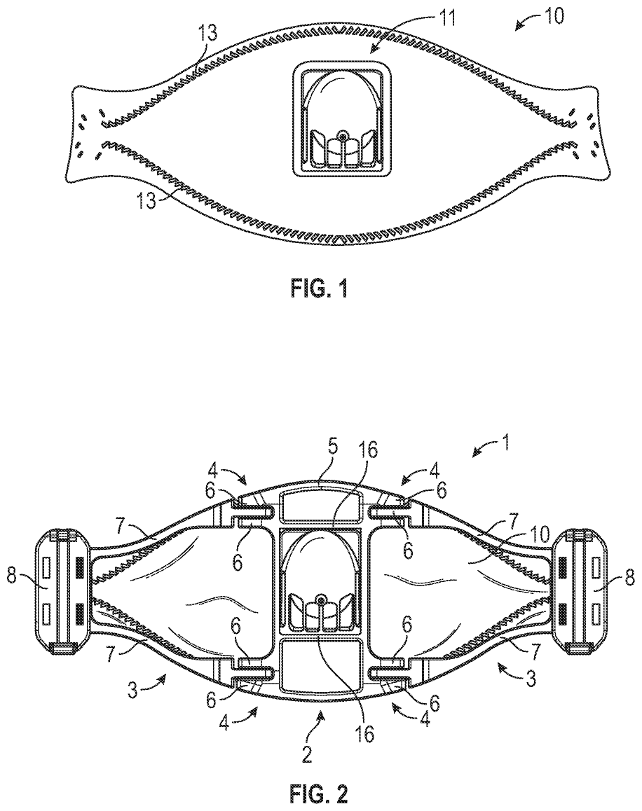

FIG. 1 is a front view of a filtering structure with an exhalation valve;

FIG. 2 is a front view of the filtering structure of FIG. 1 with a respirator carrier frame according to the invention;

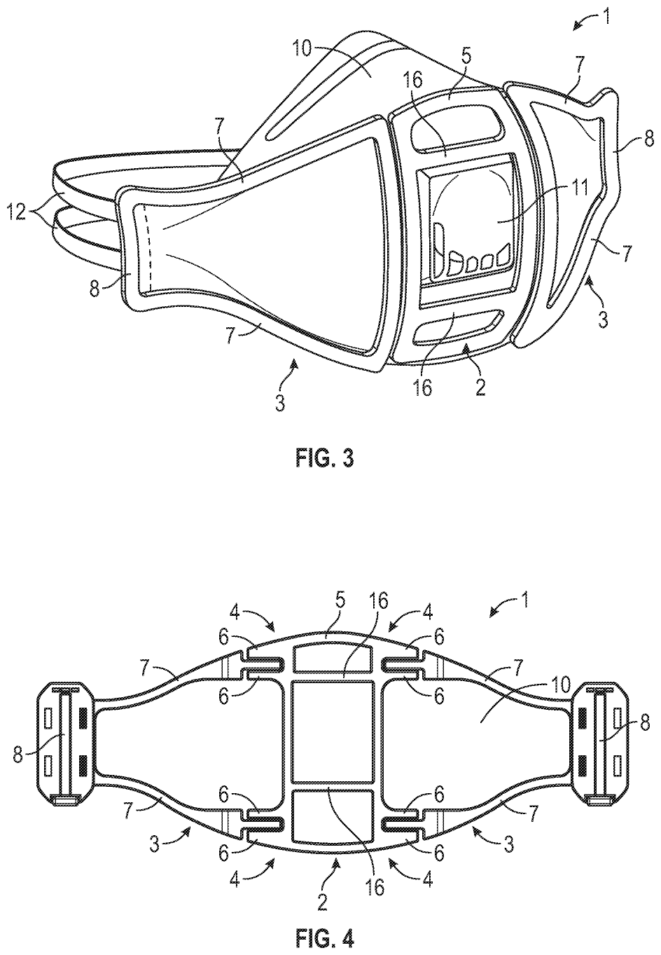

FIG. 3 is a schematic, three-dimensional view of a filtering structure with an exhalation valve and a respirator carrier frame according to the invention;

FIG. 4 is a front view of a respirator carrier frame according to the invention;

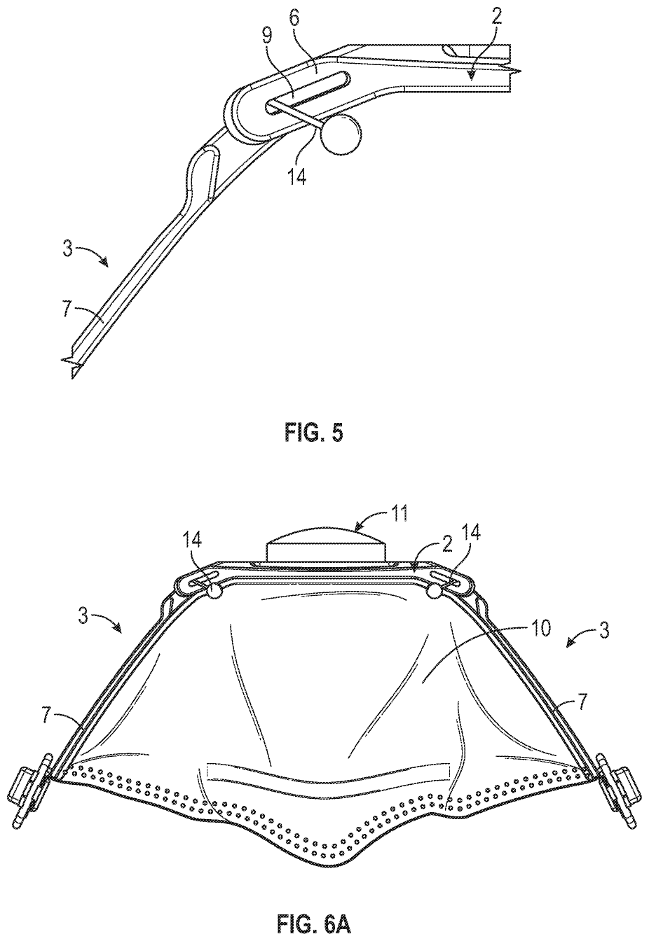

FIG. 5 is a detailed view of a hinge of the respirator carrier frame of FIG. 4 with an elongated through-hole;

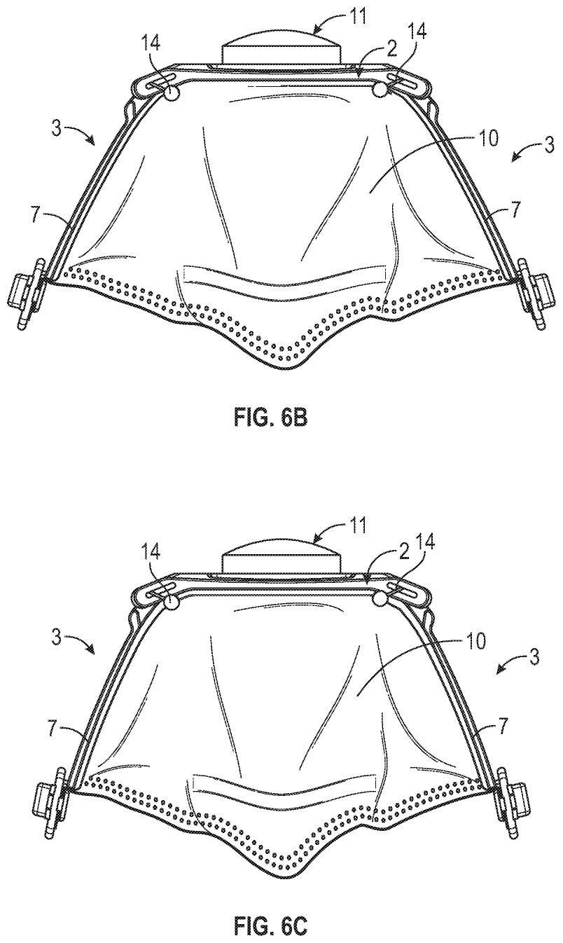

FIG. 6A to C is a series of top views of a filtering structure with a respirator carrier frame, wherein the wing portions of the respirator carrier frame are shown in different positions relative to the central frame portion;

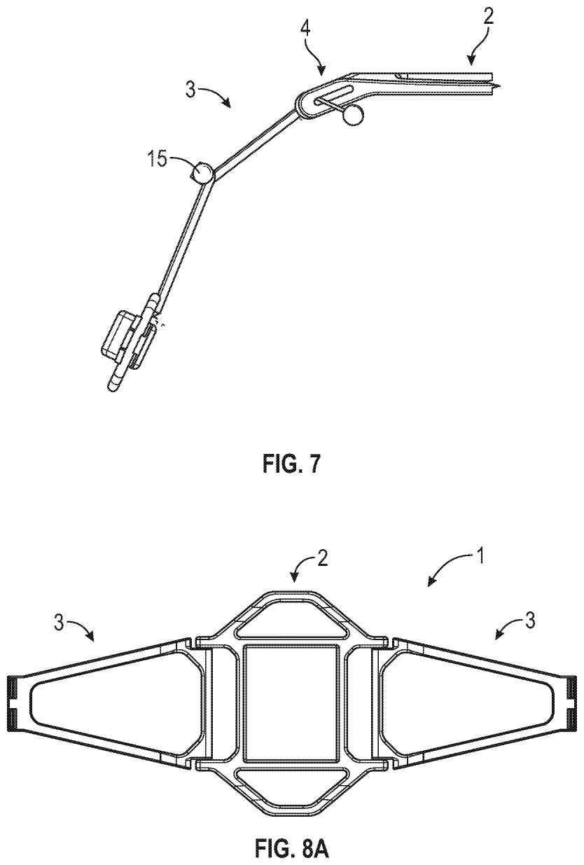

FIG. 7 is a partial top view of a respirator carrier frame showing a wing portion with an additional hinge;

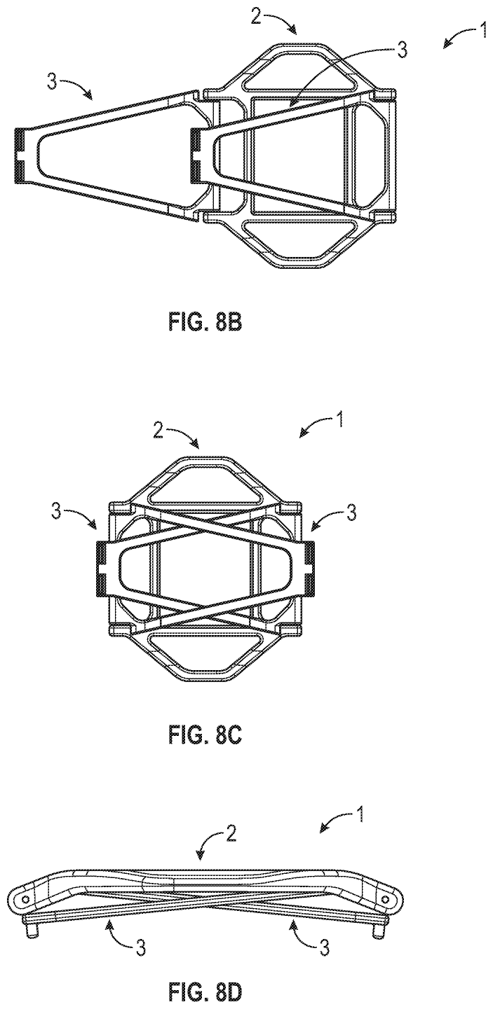

FIG. 8A to D is a series of views showing another embodiment of a respirator carrier frame in an unfolded stage as well as in different folded stages;

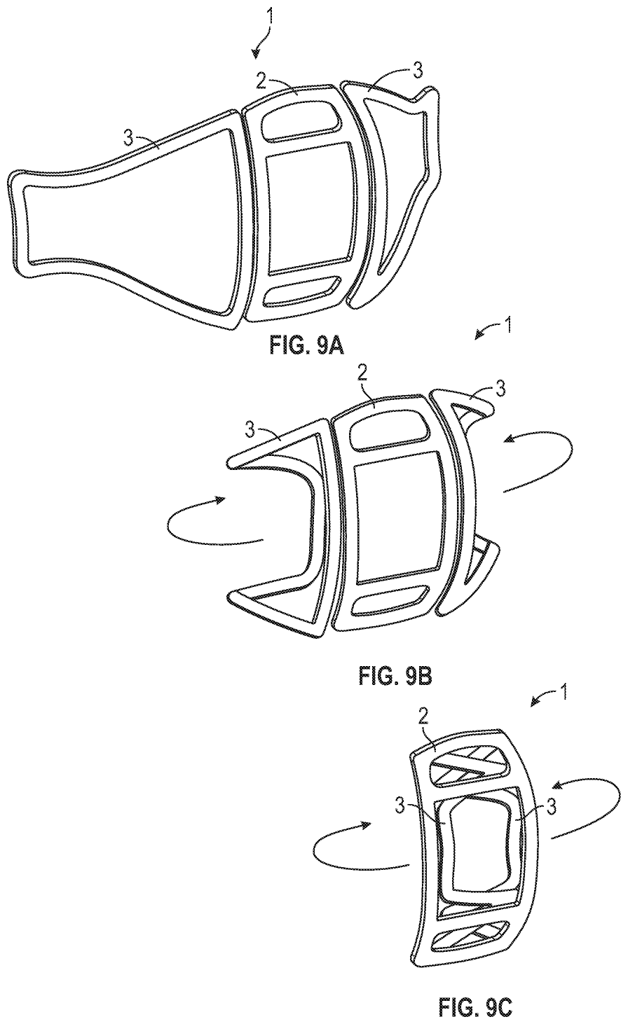

FIG. 9A to C is a series of schematical, three-dimensional views of a respirator carrier frame in an unfolded stage as well as in different folded stages, wherein the wing portion of the respirator carrier frame comprise an additional hinge and

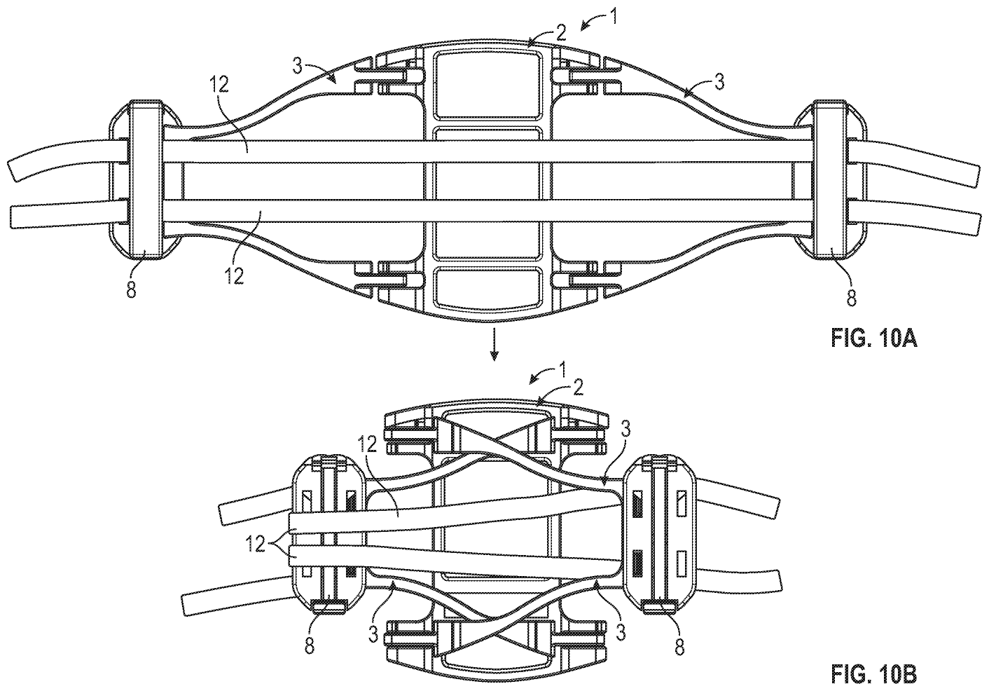

FIG. 10A and B is a series of views showing another embodiment of a respirator carrier frame with a headband in an unfolded and a folded stage.

Herein below various embodiments of the present invention are described and shown in the drawings wherein like elements are provided with the same reference numbers.

In FIG. 1 a front view of a filtering structure 10 can be seen. The filtering structure 10 is a flat folded three-part filtering structure 10. FIG. 1 shows the elliptically shaped front part of it. The narrower sides of the filtering structure are usually used to attach a headband with which the filtering structure can be fixed to a wearer's head. The two additional parts of the three-part filtering structure 10 are in the view of FIG. 1 positioned behind the front part and each attached to the front part along a connection line 13, each connection line extending along the upper and the lower edges of the front part of the filtering structure 10.

The filtering structure 10 of FIG. 1 also provides an exhalation valve 11. The exhalation valve 11 may in use be operatively connected to an interior gas space of the respirator body, which is built by the filtering structure and a wearer's face. An exhalation valve is a known means in the area of respirator systems, that helps to release a worker's hot, humid exhaled breath quickly out of the interior gas space and therefore increases the wearing comfort of the respirator body. It also closes during inhalation and prevents particles from entering the interior gas space. One example for such an exhalation valve is the 3M™ Cool Flow™ valve, commercially available from 3M Company, St. Paul, Minn. in the United States of America. In the shown embodiment, the exhalation valve 11 is positioned in the middle of the front part of the filtering structure 10. It is also possible to position the exhalation valve 11 in other areas of the filtering structure.

In FIG. 2 the same filtering structure 10 as in FIG. 1 is shown. The filtering structure 10 is attached to a respirator carrier frame 1 according to the invention. The respirator carrier frame 1 according to the invention comprise a central frame portion 2. The central frame portion 2 is essentially rectangular with a rectangular outer frame structure 5 as well as an inner stiffening structure in the form of two straight, essentially parallel stiffening bars 16 extending in a horizontal manner from one side of the outer frame structure 5 to the other side of the outer frame structure 5. The two inner stiffening bars 16 are arranged such that they—together with the vertical bars of the rectangular outer frame structure 5—provide a receiving area for the exhalation valve 11 of the filtering structure 10. The inner stiffening structure 16 as well as the outer frame structure 5 may be designed such that they provide a snap fit connection towards the housing of the exhalation valve 11 of the filtering structure 10 and therewith provide a first attachment means at the respirator carrier frame 1 for the filtering structure 10.

The central frame portion 2 further provides for hinges 4 two directed towards a first wing portion 3 and two directed towards a second opposing wing portion 3. In the embodiment shown in FIG. 2 the hinges 4 provide two parallel arms 6 that extend from the outer frame structure 5 and that are spaced apart from each other such as to receive a hinge portion of the wing portion 3. The two parallel arms 6 provide a through-hole as will be described in more detail further below.

And finally, the respirator carrier frame 1 comprises two wing portions 3, each wing portion comprising two crossbars 7 extending from the hinge 4 at the central frame portion 2 towards an outer bar 8. The two crossbars 7 are curved such that the whole respirator carrier frame 1 follows the elliptical shape of the filtering structure 10. The outer bar 8 may for example be used to hold the outer edges of the filtering structure 10, second attachment means for the filtering structure (not shown in FIG. 2) or for attaching a head band (also not shown in FIG. 2).

In FIG. 3 a schematic three-dimensional view of a filtering structure 10 with an exhalation valve 11 and a respirator carrier frame 1 according to the invention can be seen. The respirator carrier frame 1 comprises a central frame portion 2 with an essentially rectangular outer frame structure 5 and two inner stiffening bars 16 as inner stiffening structure. The respirator carrier frame 1 further comprises two opposing wing portions 3 extending on opposing sides from the central frame portion 2. The hinges 4 between the central frame portion 2 and the two opposing wing portions are not shown in this schematical view. The respirator carrier frame 1 further comprises headbands 12 that are fixed to the outer bars 8 of the wing portions 3.

In the schematic three-dimensional view of FIG. 3 the filtering structure 10 is shown in an unfolded cup-like stage. The front part of the filtering structure 10 extends essentially behind the respirator carrier frame 1. The upper part extends away from the front part of the filtering structure 10 towards a nose of a wearer to build the cup-like stage. The lower part of the filtering structure 10 is not shown in FIG. 3. The respirator carrier frame 1 is also shown in an unfolded stage. The frame 1 in its unfolded stage supports the shape of the filtering structure 10, especially of the front part of it, and stabilizes it shape.

In FIG. 4 a front view of a respirator carrier frame 1 according to the invention can be seen without any filtering structure 10. It provides the same elements that have been described with reference to FIG. 2 already.

In FIG. 5 a detailed view of a hinge 4 of the respirator carrier frame 1 of FIG. 4 is shown. The hinge 4 shown in this figure. provides an elongated through-hole 9 in the two parallel, spaced apart arms 6 (the upper arm 6 is shown in this drawing) of the hinge 4 extending from the central frame portion 2. The hinge 4 further provides a pivot 14 extending through the through-hole 9. The crossbar 7 of the wing portion 3 also provides a through-hole (not shown in FIG. 5), which is circular and not elongated. A hinge 4 with an elongated through-hole 9 at least on one side of the arms building the hinge provides the advantage that the wing portions 3 can be moved in a rotational way and in a translational way relative to the central frame portion 2. This kind of movement provides the advantage of a much more flexible moving relationship between the central frame portion 2 and the wing portions 3, which allows for much more positions that the wing portions 3 can be put in relative to the central frame portion 2. This means, that the respirator carrier frame 1 allows stabilizing and supporting a high number of different shapes of a filtering structure 10.

Please note that the pivot in all drawings of this application is shown with a spherical head. This is just for illustrative purposes to clearly indicate the pivot. In practise the pivot may be much shorter and would not provide a spherical head.

FIG. 6A to FIG. 6C show three different positions the wing portions 3 can be put in relative to the central frame portion 2. In all three figures the respirator carrier frame 1 is shown with a filtering structure 10.

In FIG. 7 a wing portion 3 of a respirator carrier frame 1 is shown connected to a central frame portion 2 via a hinge 4. The hinge 4 is exactly the same hinge as described with reference to FIG. 2 and FIG. 4. The wing portion 3 differs from the wing portions 3 described before in that it provides an additional hinge 15. The hinge 15 is positioned approximately in the middle of the wing portion 3. The hinge 15 may also be positioned at other positions of the wing portion 3 (not shown). An additional hinge 13 in the middle of the wing portion 3 provides more flexibility in folding the respirator carrier frame 1 into a space saving position. It also provides the advantage of being more flexible regarding providing the correct shape to the filtering structure 10.

The additional hinge 15 may be designed in a very simple way, by providing the two arms of the divided crossbar 7 with a circular through-hole as well as with a pivot. Such an embodiment can be seen in FIG. 7. It is of course also possible to provide the additional hinge with more elements in order to make it more stable and in order to add additional movement possibilities beyond the rotational movement possibility. The pivot may

In FIG. 8A to FIG. 8D another embodiment of a respirator carrier frame 1 can be seen. The embodiment differs from the embodiments described before in that the shape is less elliptical, since the bars of the respirator carrier frame 1 are not curved. It also differs in that the hinges 4 only comprise one arm from the central frame portion 2 and not two arms. The series of views shows how the respirator carrier frame 1 can be brought from an unfolded stage as shown in FIG. 8A to a folded stage as shown in FIG. 8C and D. First one of the wing portions 3 is folded such that it lies on the central frame portion 2 and then the second, opposing wing portion 3 is folded such that it lies on central frame portion 2 and the first wing portion 3. Looking at FIG. 8D it is shown how space saving the folded stage of the respirator carrier frame 1 can be.

FIG. 9A to C is a series of schematical, three dimensional views of a respirator carrier frame 1 with wing portions 3 with an additional hinge (the hinges themselves are not shown in FIG. 9, only the possibilities of folding). The series of views illustrates how a respirator carrier frame 1 according to this embodiment can be folded and stored in a very space saving manner.

FIG. 10A to B is a series of views showing another embodiment of a respirator carrier frame 1 with a head band 12 in an unfolded and in a folded stage. Here again it can be seen, how space saving the folded stage is for storing a respirator with a respirator carrier frame according to the invention.

1. A respirator carrier frame comprising:
a central frame portion;
two wing portions extending on opposing sides from the central frame portion
at least one hinge between the central frame portion and each of the two opposing wing portions.

2. The respirator carrier frame of claim 1, wherein the central frame portion is of essentially rectangular shape.

3. The respirator carrier frame of claim 1, wherein the central frame portion comprises comprise an outer frame structure.

4. The respirator carrier frame claim 1, wherein the central frame portion comprises an inner stiffening structure.

5. The respirator carrier frame of claim 1, wherein each of the hinges between the central frame portion and the wing portions comprises at least one arm (6) extending from the outer frame structure of the central frame portion.

6. The respirator carrier frame of claim 1, wherein each of the hinges between the central frame portion and the wing portions allows a translational and a rotational movement of the wing portions relative to the central frame portion.

7. The respirator carrier frame of claim 1, wherein each wing portion comprises two crossbars extending from the central frame portion towards an outer bar connecting the two crossbars.

8. The respirator carrier frame of claim 1, wherein the two crossbars of the wing portions comprise a through-hole to establish a hinge connection at the end of the crossbars that faces the central frame portion facing end.

9. The respirator carrier frame claim 1, wherein each wing portion provides an additional hinge for folding the wing portion in itself.

10. The respirator carrier frame according to claim 1, wherein the respirator carrier frame comprises means for attaching an attachment for a filtering structure.

11. The respirator carrier frame of claim 1, wherein the respirator carrier frame comprises headbands or electronic components.

12. The respirator carrier frame of claim 1, wherein the size and the shape of the central frame portion is adapted to receive an outer housing of an exhalation valve through a snap fit connection.

13. A kit of parts for a respirator system comprising a respirator carrier frame of claim and at least one disposable filtering structure.
